(19) United States
(12) Patent Application Publication
(10) Pub. No.: US 2025/0020489 A1
(43) Pub. Date: Jan. 16, 2025

(54) ROTOR FOR INDUCTIVE POSITION SENSOR

(71) Applicant: SEMICONDUCTOR COMPONENTS INDUSTRIES, LLC, Scottsdale, AZ (US)

(72) Inventor: Jacques Jean BERTIN, Pocatello, ID (US)

(73) Assignee: SEMICONDUCTOR COMPONENTS INDUSTRIES, LLC, Scottsdale, AZ (US)

(21) Appl. No.: 18/430,787

(22) Filed: Feb. 2, 2024

Related U.S. Application Data
(60) Provisional application No. 63/513,498, filed on Jul. 13, 2023.

(51) Int. Cl. G01D 5/22

(52) U.S. Cl. CPC G01D 5/22

(57) ABSTRACT

An inductive position sensor subsystem is disclosed. The inductive position sensor includes a fine rotor located on a first printed circuit board, and a metallic coarse rotor including a metal support to which the first printed circuit board is coupled. The inductive position sensor also includes a fine sensor receiver and a coarse sensor receiver that generate respective pluralities of sensor signals based on the rotation of the fine rotor and the metallic coarse rotor. The fine sensor receiver and the coarse sensor receiver are located on a second printed circuit board separate from the first printed circuit board.

### CROSS-REFERENCE TO RELATED APPLICATIONS

The present application claims benefit of U.S. Provisional Application No. 63/513,498 titled “Rotor for Inductive Position Sensor,” filed Jul. 13, 2023, the content of which is incorporated by reference herein in its entirety for all purposes.

### TECHNICAL FIELD

This disclosure is related to sensors and, more particularly, to inductive angular position sensors.

### BACKGROUND

In many computer and mechanical systems, a variety of sensors may be employed to detect different environmental and operational conditions, and to generate analog or digital signals corresponding to the detected conditions. In some systems, temperature sensors may be employed to detect the temperature of a system in order to determine if the system is operating in a specified temperature range. Other systems may employ accelerometer sensors to aid in the determination of movement of the system or part of the system. In robotic systems, rotational sensors may be used to determine how far a portion of a system, e.g., a robotic arm, has rotated.

### SUMMARY

Various embodiments of an inductive position sensor are disclosed. Broadly speaking, an inductive position sensor includes a fine rotor located on a first printed circuit board, and a metallic coarse rotor including a metal support to which the first printed circuit board is coupled. The inductive position sensor also includes a fine sensor receiver configured to generate a plurality of fine sensor signals based on a first rotation of the fine rotor, and a coarse sensor receiver configured to generate a plurality of coarse sensor signals based on a second rotation of the metallic coarse rotor. The fine sensor receiver and the coarse sensor receiver are located on a second printed circuit board separate from the first printed circuit board.

### BRIEF DESCRIPTION OF THE DRAWINGS

For a detailed description of example embodiments, reference will now be made to the accompanying drawings in which:

FIG. 1 is a block diagram of an embodiment of a sensor subsystem.

FIG. 2 is an exploded perspective view of an embodiment of a rotor assembly for a sensor.

FIG. 3 is a top view of an embodiment of sensor receivers.

FIG. 4 is a cross-section diagram of an embodiment of a sensor with a metallic coarse rotor.

FIG. 5 is a cross-section diagram of an embodiment of a sensor with fine and coarse rotors on a common printed circuit board.

FIG. 6 is a cross-section diagram of a different embodiment of a sensor with fine and coarse rotors on a common printed circuit board.

FIG. 7 is a cross-section diagram of another embodiment of a sensor with fine and coarse rotors on a common printed circuit board.

FIG. 8 is a top-view of an embodiment of a printed circuit board rotor assembly.

FIG. 9 is a flow diagram of an embodiment of a method for operating a sensor with a metallic coarse rotor.

FIG. 10 is a flow diagram of an embodiment of a method for operating a sensor with fine and coarse rotors on a common printed circuit board.

FIG. 11 is a block diagram of an embodiment of a system to control rotation of a portion of a mechanical device.

Many of the electrical connections in the drawings are shown as direct couplings having no intervening devices, but are not expressly stated as such in the following description. Nevertheless, this paragraph shall serve as antecedent basis in the claims for referencing any electrical connection as “directly coupled” for electrical connections shown in the drawings with no intervening device(s).

### Definitions

Various terms are used to refer to particular system components. Different companies may refer to a component by different names—this document does not intend to distinguish between components that differ in name but not function. In the following discussion and in the claims, the terms “including” and “comprising” are used in an open-ended fashion and thus should be interpreted to mean “including, but not limited to . . . ” Also, the term “couple” or “couples” is intended to mean either an indirect or direct connection. Thus, if a first device couples to a second device, that connection may be through a direct connection or through an indirect connection via other devices and connections.

“A,” “an,” and “the,” as used herein, refers to both singular and plural referents unless the context clearly dictates otherwise. By way of example, “a processor” programmed to perform various functions refers to one processor programmed to perform each and every function, or more than one processor collectively programmed to perform each of the various functions.

In relation to electrical devices (whether stand alone or as part of an integrated circuit), the terms “input” and “output” refer to electrical connections to the electrical devices, and shall not be read as verbs requiring action. For example, a differential amplifier (such as an operational amplifier) may have a first differential input and a second differential input, and these “inputs” define electrical connections to the operational amplifier, and shall not be read to require inputting signals to the operational amplifier.

“Controller” or “controller circuit” shall mean, alone or in combination, individual circuit components, an application specific integrated circuit (ASIC), a microcontroller with controlling software, a reduced-instruction-set computing (RISC) circuit with controlling software, a digital signal processor (DSP), a processor with controlling software, a programmable logic device (PLD), a field programmable gate array (FPGA), or a programmable system-on-a-chip (PSOC), configured to read inputs and drive outputs responsive to the inputs.

### DETAILED DESCRIPTION

Various sensor circuits may be used in a variety of computer, mechanical, and electro-mechanical systems. Such sensor circuits determine and relay environmental and/or operational information that can be used as part of a control mechanism. For example, to control servo motors, robotic arms, and collaborative robots (referred to as “cobots”), multiple rotation sensors may be employed.

One type of rotation sensor that can be employed in systems is an inductive angular position sensor. In such a sensor, an excitation coil may be fabricated on a printed circuit board (“PCB”), while a rotor that is made from conductive material is connected to an object whose rotation is to be measured and rotates above the PCB and excitation coil.

When a current is driven through the excitation coil, a resultant magnetic field induces a current in the rotor. As the induced current flows in the rotor, another magnetic field is generated around the rotor which, in turn, induces respective currents or voltages in one or more receiver coils (referred to as “stators”) that are also fabricated on the PCB.

The coupling of the magnetic field of the rotor into the one or more stators is a function of the angular position of the rotor to the stators. By measuring the voltage polarity and the voltage amplitude induced in the stators, the angle of the rotor relative to the stators can be determined.

In cases where two stators are employed, each with a different rotational symmetry over the measurement range, the signals from the two stators resolve to a unique angular position of the rotor provided that the only common factor between the rotational symmetries is 1 (referred to as being “co-prime” or “relatively prime”). While such an arrangement of a rotor and stators is relatively immune to rotor eccentricity (i.e., the center of rotation is not above the center of the stator) and rotor tilt (i.e., the axis of rotation is not perpendicular to the plane of the stator), error can result from a lateral movement and tilt of the rotor.

Rotors can be fabricated on a single-layer printed circuit board or made from a machined piece of metal that matches the receiver coil's geometry. Such rotors may be rigid and firmly attached to a shaft that is attached to an object being rotated, where the shaft is perpendicular to the stator.

Machined rotors that meet the mounting requirements cannot be machined to match the fine geometries used in Vernier sensor coils. Rotors fabricated on printed circuit boards can be made with the fine geometries for Vernier sensor coils, but mounting such rotors can prove difficult, as any piece of overlapping metal can result in a short circuit, which can decrease the sensor signals.

The embodiments described herein may provide techniques for implementing a sensor that uses a hybrid rotor solution that employs a combination of a metallic coarse rotor and a printed circuit board based fine rotor. Such a combination enables the metallic coarse rotor to support the fine rotor, thereby enabling the fine rotor to be positioned close to the stator in order to increase signal amplitudes while decreasing harmonic distortion.

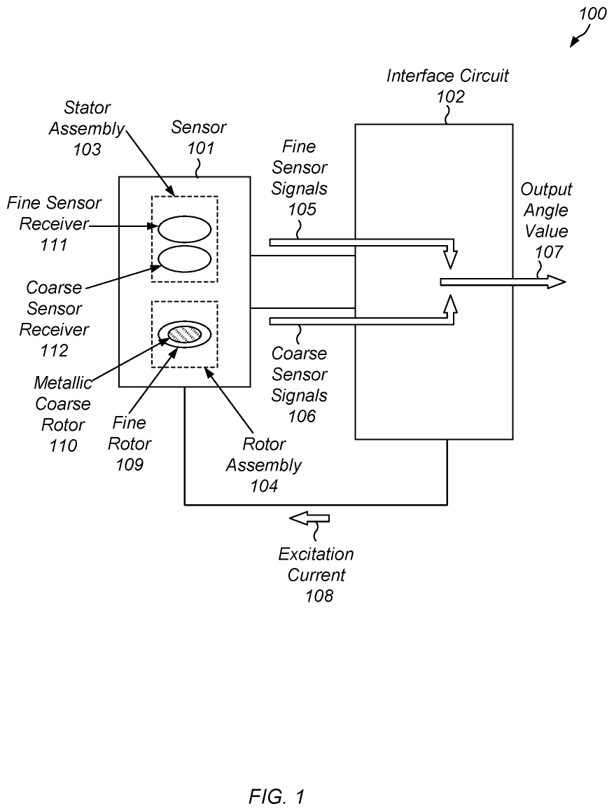

A block diagram of a sensor subsystem is depicted in FIG. 1. As illustrated, sensor subsystem 100 includes sensor 101 and interface circuit 102. In various embodiments, sensor 101 includes stator assembly 103 and rotor assembly 104. As described below, stator assembly 103 includes fine sensor receiver 111 and coarse sensor receiver 112, while rotor assembly 104 includes fine rotor 109 and metallic coarse rotor 110.

In various embodiments, fine rotor 109 is located on a particular printed circuit board. Metallic coarse rotor 110 is coupled to the particular printed circuit board. For example, the metallic coarse rotor 110 may be a machined-metal rotor that supports the printed circuit board of the fine rotor 109. In some embodiments, the thickness of fine rotor 109 may be on the order of 1 mm, while the thickness of metallic coarse rotor 110 may be in excess of 5 mm. Accordingly, metallic coarse rotor 110 may be at least five times as thick as fine rotor 109. As described below, metallic coarse rotor 110 may be coupled to the particular printed circuit board using any suitable combination of screws, rivets, bolts, and adhesives.

Fine sensor receiver 111 is configured to generate fine sensor signals 105 based on a rotation of fine rotor 109. In a similar fashion, coarse sensor receiver 112 is configured to generate coarse sensor signals 106 based on a rotation of metallic coarse rotor 110. In various embodiments, fine sensor receiver 111 and coarse sensor receiver 112 are located on a different printed circuit board separate from the particular printed circuit board. It is noted that, in various embodiments, fine sensor signals 105 and coarse sensor signals 106 can each include at least two sensor signals. The use of multiple fine and coarse sensor signals can, in some embodiments, allow for a more accurate determination of a rotation angle.

In various embodiments, interface circuit 102 is configured to generate output angle value 107 using fine sensor signals 105 and coarse sensor signals 106. In some cases, to generate output angle value 107, interface circuit 102 is further configured to perform one or more analog-to-digital conversion operations on fine sensor signals 105 and coarse sensor signals 106. In some embodiments, interface circuit 102 is also configured to generate excitation current 108, which may be applied to an excitation coil in stator assembly 103.

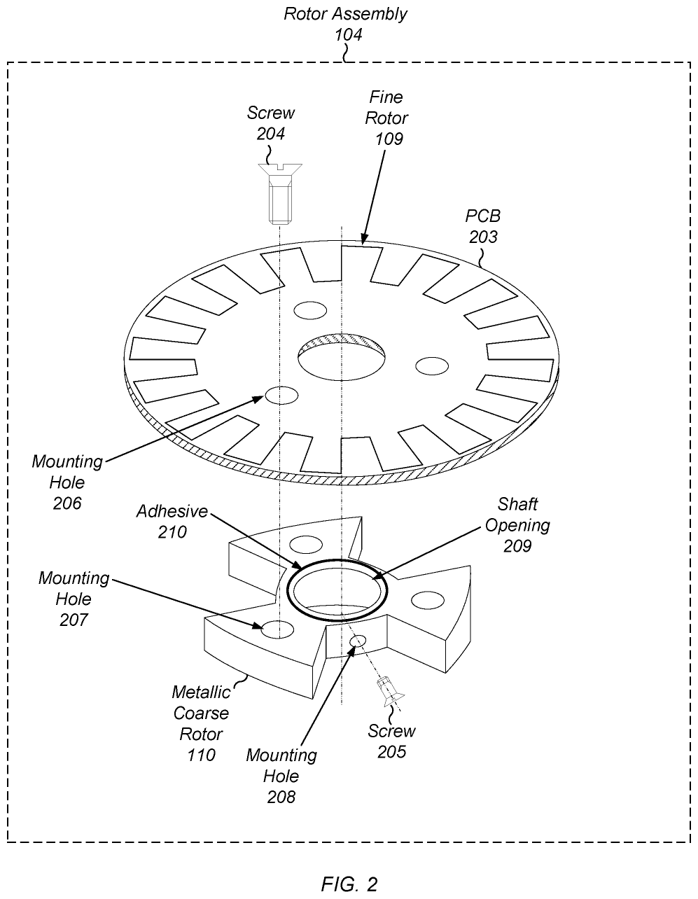

Turning to FIG. 2, an exploded perspective view of rotor assembly 104 is depicted. As illustrated, rotor assembly 104 includes fine rotor 109 and metallic coarse rotor 110. In various embodiments, fine rotor 109 is fabricated on printed circuit board 203 (denoted as “PCB 203”).

Fine rotor 109 may, in various embodiments, be fabricated on PCB 203 using copper or any other suitable material. PCB 203 may include multiple instances of mounting hole 206 that can be used to couple PCB 203 to metallic coarse rotor 110. By fabricating fine rotor 109 on PCB 203, a fine structure can be achieved to enable high resolution in measuring rotation. As described below, with the support provided by metallic coarse rotor 110, PCB 203 may be located close enough to stator assembly 103 to improve signal amplitude of fine sensor signals 105 while reducing harmonic distortion.

Metallic coarse rotor 110 includes multiple instances of mounting hole 207, which are used to couple metallic coarse rotor 110 to corresponding instances of mounting hole 206 on PCB 203 using one or more of screw 204. Alternatively, or additionally, metallic coarse rotor 110 may be attached to PCB 203 using adhesive 210. In various embodiments, adhesive 210 may be thermally and/or electrically conductive. Although adhesive 210 is depicted as surrounding shaft opening 209, in other embodiments, adhesive 210 may be used in any suitable location on metallic coarse rotor 110 that can be attached to PCB 203.

Metallic coarse rotor 110 further includes shaft opening 209. In various embodiments, a diameter of shaft opening 209 may be based, at least in part, on a diameter of a shaft (not pictured) connected to an object whose rotation is to be sensed. In various embodiments, metallic coarse rotor 110 is attached to the shaft by inserting screw 205 into mounting hole 208 until it makes contact with the shaft. Although the embodiment of FIG. 2 depicts the use of screw 204 and screw 205, in other embodiments, screws 204 and 205 may be replaced with any suitable combination of rivets, bolts, adhesives, or other suitable coupling hardware.

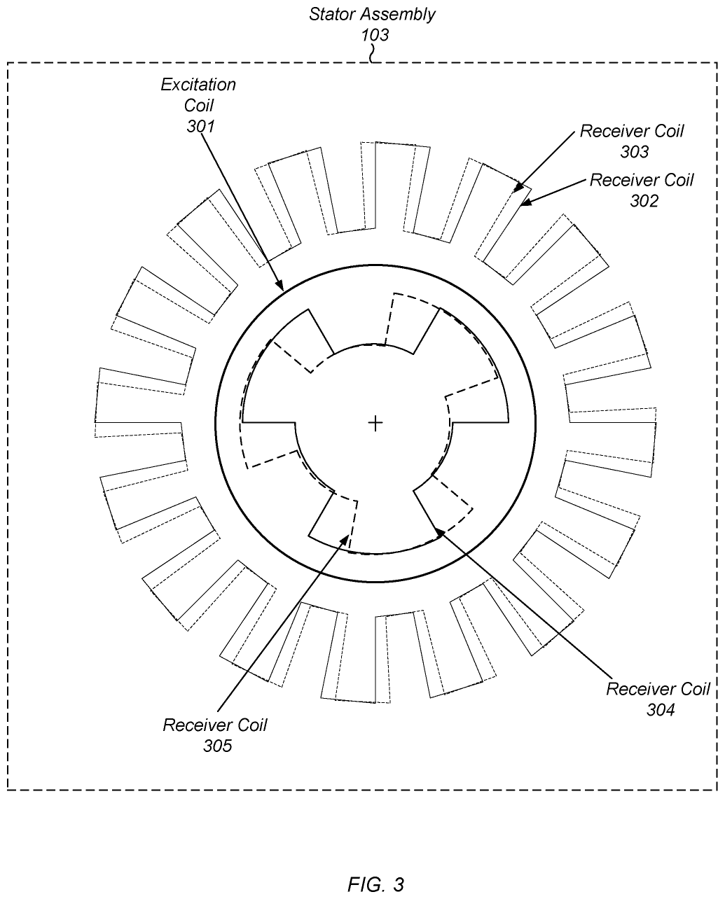

Turning to FIG. 3, a top view of an embodiment of stator assembly 103 is depicted. As illustrated, stator assembly 103 includes excitation coil 301, and receiver coils 302-305. In various embodiments, receiver coils 302 and 303 form a fine sensor receiver that is configured to generate fine sensor signals 105, while receiver coils 304 and 305 form a coarse sensor receiver that is configured to generate coarse sensor signals 106.

Excitation coil 301 is fabricated (or “printed”) on a printed circuit board or “PCB” (not shown). In various embodiments, excitation coil 301 is fabricated using copper or any other suitable material that can be printed on a PCB. Although excitation coil 301 is depicted as a single trace, in other embodiments, excitation coil 301 may include multiple concentric traces.

Receiver coils 302-305 are also fabricated from a conductive material on the PCB. In various embodiments, receiver coils 302 and 303 have different geometries than receiver coils 304 and 305. In some cases, receiver coils 302 and 303 may have more loops away from the center to increase resolution relative to receiver coils 304 and 305. Although only two receiver coils are depicted for each of the fine and coarse sensor receivers in the embodiment of FIG. 3, in other embodiments, any suitable number of receiver coils may be employed for the fine and coarse sensor receivers.

To measure the rotation, interface circuit 102 is configured to apply an alternating current signal to excitation coil 301. As the alternating current flows in excitation coil 301, a magnetic field is generated around excitation coil 301. In various embodiments, the coupling from excitation coil 301 to fine rotor 109 and coarse rotor 110 is independent of the angular position of fine rotor 109 and 110, but is a function of a distance between excitation coil 301 and fine rotor 109 and coarse rotor 110.

The magnetic field generated by excitation coil 301 induces currents in fine rotor 109 and coarse rotor 110, which, in turn, generates a magnetic field around fine rotor 109 and coarse rotor 110. The respective magnetic fields generated by the induced current in fine rotor 109 and coarse rotor 110 superimpose to form a composite magnetic field which couples into receiver coils 302-305. The coupling from a given rotor to a given receiver coil is a function of both the distance between the given rotor and the given receiver coil, as well as the angular position of the given rotor and the given receiver coil. It is noted, however, that since fine rotor 109 has a different rotational symmetry than receiver coils 304 and 305, there is minimal coupling between fine rotor 109 and receiver coils 304 and 305. In a similar fashion, since coarse rotor 110 has a different rotational symmetry than receiver coils 302 and 303, there is minimal coupling between coarse rotor 110 and receiver coils 302 and 303.

The magnetic field generated by fine rotor 109 induces respective currents or voltages in both receiver coils 302 and 303, while coarse rotor 110 induces respective currents or voltages in both receiver coils 304 and 305. As described below, interface circuit 102 is configured to measure the polarity and amplitude of the respective voltages of receiver coils 302-305. Using the polarity and amplitude measurements, interface circuit 102 is further configured to determine output angle value 107. As described above, a number of periods in the signals of receiver coils 302 and 303 can depend on the geometry of receiver coils 302 and 303, while a number of periods in the signals of receiver coils 304 and 305 can depend on the geometry of receiver coils 304 and 305. In various embodiments, receiver coils 302 and 303 may generate fine sensor signals 105, while receiver coils 304 and 305 may generate coarse sensor signals 106.

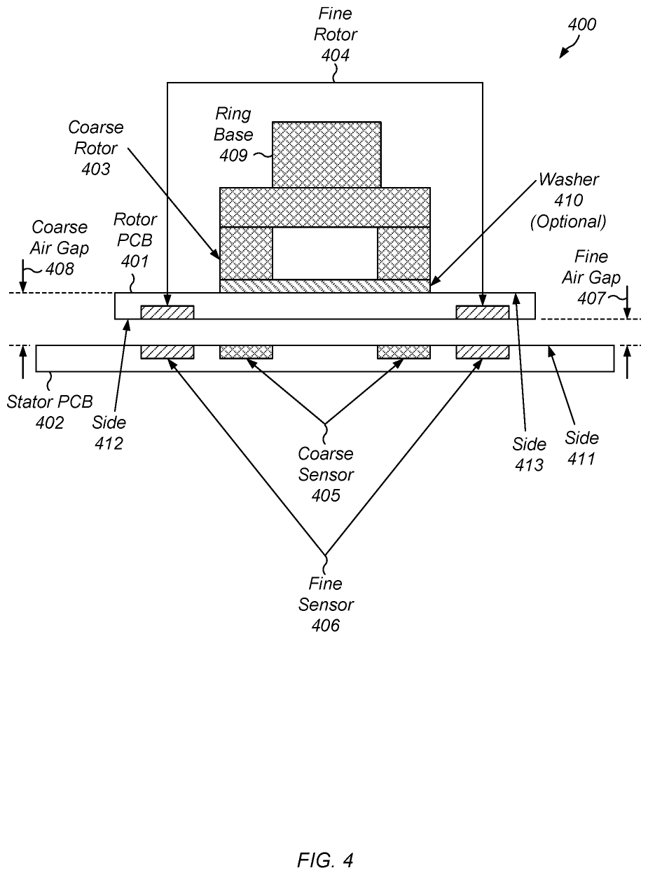

Turning to FIG. 4, a cross-section diagram of an embodiment of a sensor is depicted. As illustrated, sensor 400 includes rotor PCB 401, stator PCB 402, and coarse rotor 403. In various embodiments, sensor 400 may correspond to sensor 101 as depicted in FIG. 1.

Coarse rotor 403 may, in various embodiments, correspond to coarse rotor 110 as depicted in the embodiment of FIG. 2. As described above, coarse rotor 403 may be coupled to side 413 of rotor PCB 401 using one or more screws, rivets, bolts, or any suitable adhesive. In some embodiments, coarse rotor 403 includes ring base 409 (also referred to as a “support”). In such cases, ring base 409 may be coupled, via one or more screws, rivets, or bolts, to a shaft that is attached to an object subject to rotation. Coarse rotor 403 and ring base 409 may be fabricated using any suitable metallic material.

Rotor PCB 401 includes fine rotor 404. In various embodiments, fine rotor 404 is located on side 412 of rotor PCB 401. Side 412 may, in some embodiments, be opposite side 413 of rotor PCB 401. In various embodiments, fine rotor 404 may be fabricated using copper or any other suitable material that can be printed on rotor PCB 401.

Coarse sensor 405 and fine sensor 406 are located on side 411 of stator PCB 402. In various embodiments, coarse sensor 405 and fine sensor 406 may have different rotational symmetries. In some embodiments, coarse sensor 405 and fine sensor 406 may be fabricated using copper or any other suitable material that can be printed on stator PCB 402.

In various embodiments, rotor PCB 401 and stator PCB 402 are positioned relative to each other such that fine rotor 404 is separated from fine sensor 406 by fine air gap 407. Such a position also results in coarse rotor 403 being separated from coarse sensor 405 by coarse air gap 408. It is noted that, in this arrangement, fine air gap 407 is less than coarse air gap 408. In some cases, optional washer 410 can be included between coarse rotor 403 and rotor PCB 401 to increase the size of coarse air gap 408. In various embodiments, optional washer 410 can be fabricated from any suitable non-conductive material.

In some cases, the coarse rotor 403 can also be included on the same printed circuit board as the fine rotor 404. By including the fine and coarse rotors on the same printed circuit, the spacing between the rotors and their corresponding receiver coils can be adjusted by changing which sides of the printed circuit boards the different rotors and receiver coils are located.

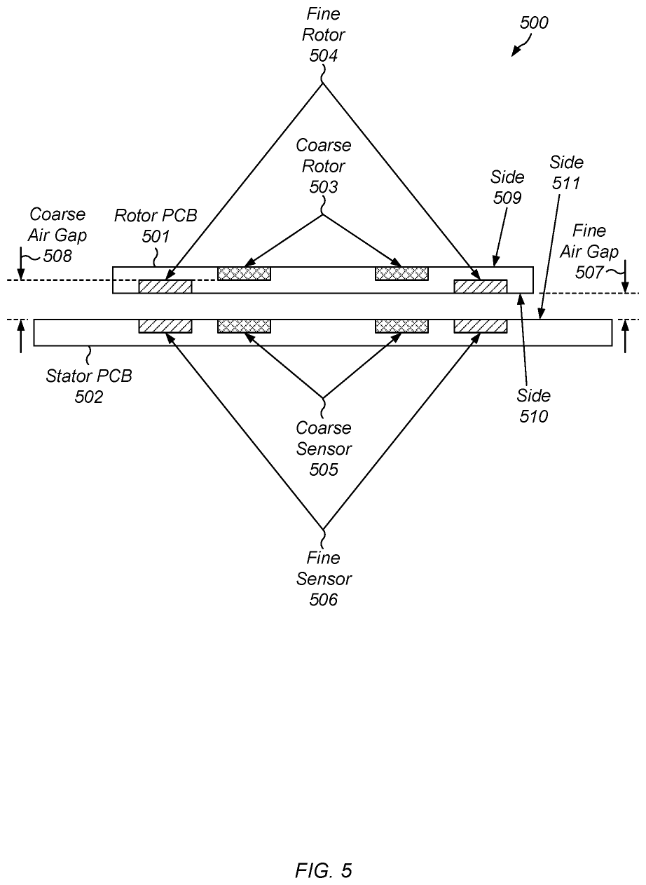

A cross-section diagram of an embodiment of a sensor that includes two printed circuit boards is depicted in FIG. 5. As illustrated, sensor 500 includes rotor PCB 501 and stator PCB 502. Rotor PCB 501 includes coarse rotor 503 and fine rotor 504, while stator PCB 502 includes coarse sensor 505 and fine sensor 506. In various embodiments, sensor 500 may correspond to sensor 101 as depicted in FIG. 1.

Coarse rotor 503 is located on side 509 of rotor PCB 501, while fine rotor 504 is located on side 510 of rotor PCB 501. As depicted, side 510 of rotor PCB 501 is opposite side 509 of rotor PCB 501. In various embodiments, coarse rotor 503 and fine rotor 504 are fabricated using copper or any other suitable material that can be printed on rotor PCB 501. In some embodiments, coarse rotor 503 and fine rotor 504 may have different rotational symmetries.

Coarse sensor 505 and fine sensor 506 are located on side 511 of stator PCB 502. In various embodiments, coarse sensor 505 and fine sensor 506 may have different rotational symmetries. In some embodiments, coarse sensor 505 and fine sensor 506 may be fabricated using copper or any other suitable material that can be printed on stator PCB 502.

In various embodiments, rotor PCB 501 and stator PCB 502 are positioned relative to each other such that fine rotor 504 is separated from fine sensor 506 by fine air gap 507. Such a position also results in coarse rotor 503 being separated from coarse sensor 505 by coarse air gap 508. It is noted that, in this arrangement, fine air gap 507 is less than coarse air gap 508, which increases the coupling between fine rotor 504 and fine sensor 506.

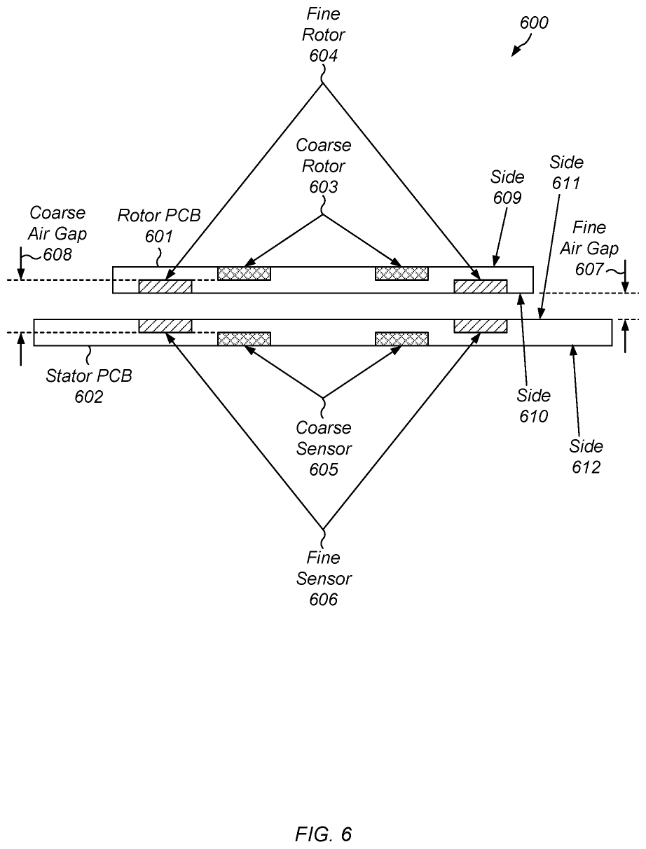

Turning to FIG. 6, a cross-section of a different embodiment of a sensor is depicted. As illustrated, sensor 600 includes rotor PCB 601 and stator PCB 602. Rotor PCB 601 includes coarse rotor 603 and fine rotor 604, while stator PCB 602 includes coarse sensor 605 and fine sensor 606. In various embodiments, sensor 600 may correspond to sensor 101 as depicted in FIG. 1.

Coarse rotor 603 is located on side 609 of rotor PCB 601, while fine rotor 604 is located on side 610 of rotor PCB 601. As depicted, side 610 is on an opposite side of rotor PCB 601 than side 609. In various embodiments, coarse rotor 603 and fine rotor 604 are fabricated using copper or any other suitable material that can be printed on rotor PCB 601. In some embodiments, coarse rotor 603 and fine rotor 604 may have different rotational symmetries.

Fine sensor 606 is located on side 611 of stator PCB 602, while coarse sensor 605 is located on side 612 of stator PCB 602. As depicted, side 611 is on an opposite side of stator PCB 602 than side 612. In various embodiments, coarse sensor 605 and fine sensor 606 may have different rotational symmetries. In some embodiments, coarse sensor 605 and fine sensor 606 may be fabricated using copper or any other suitable material that can be printed on stator PCB 602.

In various embodiments, rotor PCB 601 and stator PCB 602 are positioned relative to each other such that fine rotor 604 is separated from fine sensor 606 by fine air gap 607. Such a position also results in coarse rotor 603 being separated from coarse sensor 605 by coarse air gap 608. It is noted that, in this arrangement, fine air gap 607 is less than coarse air gap 608.

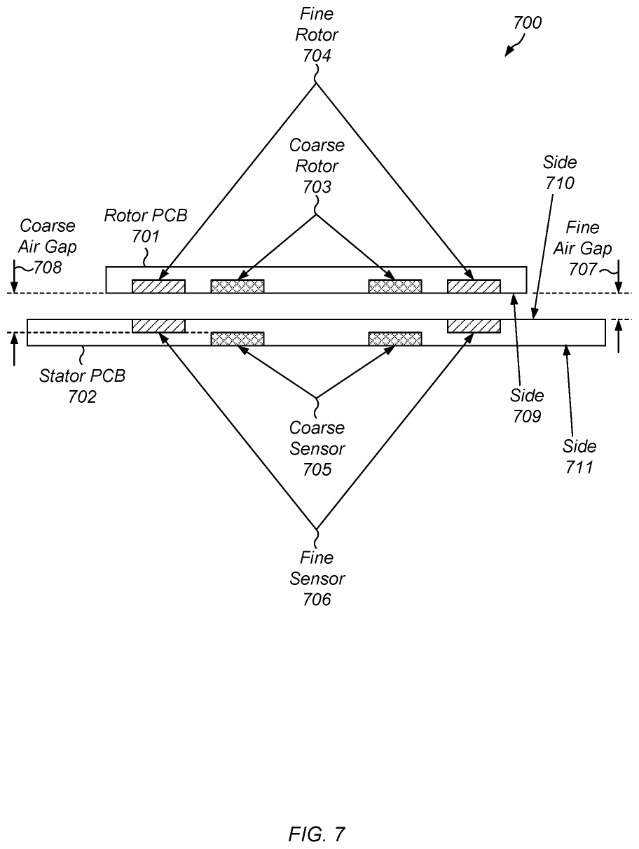

Turning to FIG. 7, a cross-section of a different embodiment of a sensor is depicted. As illustrated, sensor 700 includes rotor PCB 701 and stator PCB 702. Rotor PCB 701 includes coarse rotor 703 and fine rotor 704, while stator PCB 702 includes coarse sensor 705 and fine sensor 706. In various embodiments, sensor 700 may correspond to sensor 101 as depicted in FIG. 1.

Coarse rotor 703 and fine rotor 704 are located on side 709 of rotor PCB 701. In various embodiments, coarse rotor 703 and fine rotor 704 are fabricated using copper or any other suitable material that can be printed on rotor PCB 701. In some embodiments, coarse rotor 703 and fine rotor 704 may have different rotational symmetries.

Fine sensor 706 is located on side 710 of stator PCB 702, while coarse sensor 705 is located on side 711 of stator PCB 702. As depicted, side 710 is on an opposite side of stator PCB 702 than side 711. In various embodiments, coarse sensor 705 and fine sensor 706 may have different rotational symmetries. In some embodiments, coarse sensor 705 and fine sensor 706 may be fabricated using copper or any other suitable material that can be printed on stator PCB 702.

In various embodiments, rotor PCB 701 and stator PCB 702 are positioned relative to each other such that fine rotor 704 is separated from fine sensor 706 by fine air gap 707. Such a position also results in coarse rotor 703 being separated from coarse sensor 705 by coarse air gap 708. It is noted that, in this arrangement, fine air gap 707 is less than coarse air gap 708.

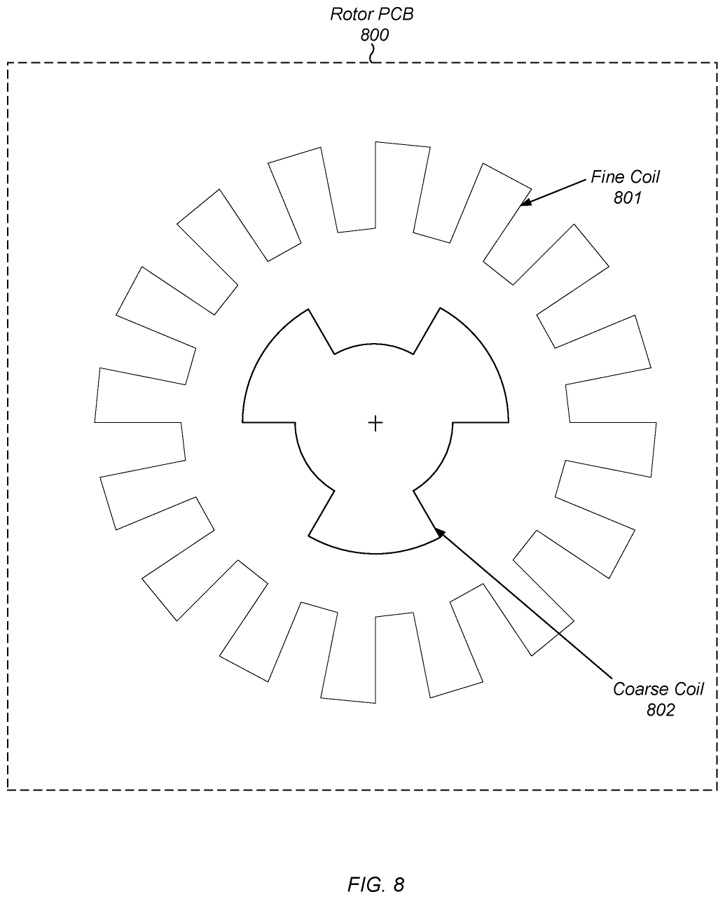

Turning to FIG. 8, a top-view of an embodiment of a printed circuit board rotor assembly is depicted. As illustrated, rotor printed circuit board 800 (denoted “Rotor PCB 800”) includes fine coil 801 to form a fine rotor, and coarse coil 802 to form a coarse rotor. In various embodiments, rotor PCB 800 may correspond to any of rotor PCB 501, rotor PCB 601, or rotor PCB 701 as depicted in FIGS. 5, 6, and 7, respectively.

In various embodiments, fine coil 801 and coarse coil 802 may be fabricated on a common side of rotor PCB 800. Alternatively, fine coil 801 and coarse coil 802 may be fabricated on opposite sides of rotor PCB 800. In some embodiments, fine coil 801 and coarse coil 802 may be implemented using copper or any other suitable metal available in a printed circuit board manufacturing process.

As illustrated fine coil 801 has a higher count per revolution than coarse coil 802. In various embodiments, the respective counts per revolution of fine coil 801 and coarse coil 802 may be based on a physical size of a rotational sensor, a desired level of accuracy for the rotational sensor, or any other suitable characteristic of the rotational sensor. In some cases, the count per revolution of fine coil 801 may typically be higher than 10, with values such as 16, 32, or higher, being common. In contrast, the count per revolution of coarse coil 802 may typically be less than 10, with values such as 3 or 5 being common.

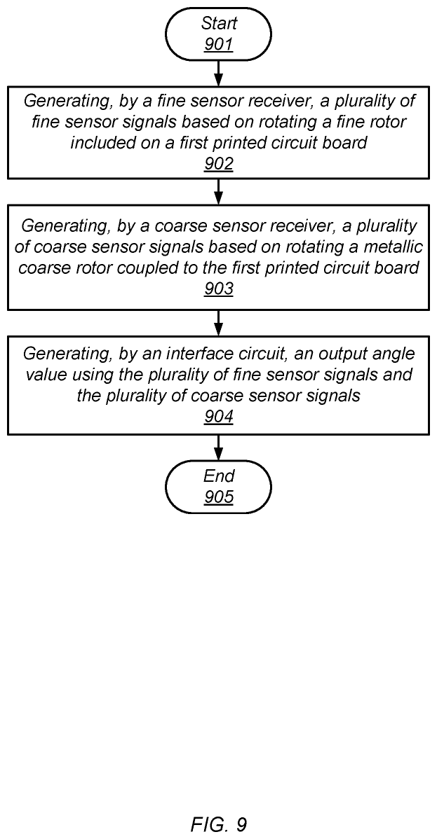

Turning to FIG. 9, a flow diagram depicting an embodiment of a method for operating a sensor subsystem is illustrated. The method, which may be applied to various sensor subsystems, e.g., sensor subsystem 100, begins in block 901.

The method includes generating, by a fine sensor receiver, a plurality of fine sensor signals based on rotating a fine rotor included on a first printed circuit board (block 902). In various embodiments, the fine sensor receiver may include a plurality of first coils fabricated from a conductive material on the first printed circuit board.

The method also includes generating, by a coarse sensor receiver, a plurality of coarse sensor signals based on rotating a metallic coarse rotor coupled to the first printed circuit board (block 903). In various embodiments, the coarse sensor receiver may include a plurality of second coils fabricated from the conductive material on the first printed circuit board. The rotational symmetry of the fine sensor receiver is different than the rotational symmetry of the coarse sensor receiver, such that the fine sensor receiver can measure the rotation of the fine rotor with a higher resolution than the coarse sensor receiver can measure the rotation of the metallic coarse rotor.

In various embodiments, the metallic coarse rotor is coupled to the first printed circuit board using at least one screw. In other embodiments, the metallic coarse rotor is coupled to the first printed circuit board using glue or any other suitable adhesive. In some embodiments, the metallic coarse rotor is coupled to the first printed circuit board via an insulating washer.

In various embodiments, the fine sensor receiver and the coarse sensor receiver are located on a second printed circuit board separate from the first printed circuit board. In some cases, the fine sensor receiver and the coarse sensor receiver are located on a common side of the second printed circuit board. In some embodiments, a first distance between the first printed circuit board and the second printed circuit board is less than a second distance between the metallic coarse rotor and the second printed circuit board.

The method further includes generating, by an interface circuit, an output angle value using the plurality of fine sensor signals and the plurality of coarse sensor signals (block 904). In various embodiments, generating the output angle value includes performing a plurality of analog-to-digital conversion operations on the plurality of fine sensor signals and the plurality of coarse sensor signals. The method concludes in block 905.

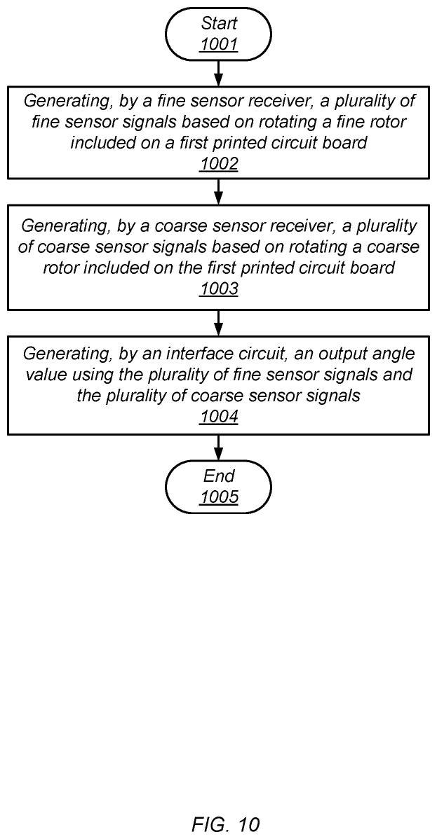

Turning to FIG. 10, a flow diagram depicting an embodiment of a method for operating a sensor subsystem with fine and coarse rotors on a common printed circuit board is illustrated. The method, which may be applied to various sensor subsystem, e.g., sensor subsystem 100, begins in block 1001.

The method includes generating, by a fine sensor receiver, a plurality of fine sensor signals based on rotating a fine rotor included on a first printed circuit board (block 1002). In various embodiments, the fine sensor receiver is included on a second printed circuit board separate from the first printed circuit board.

The method also includes generating, by a coarse sensor receiver, a plurality of coarse sensor signals based on rotating a coarse rotor included on the first printed circuit board (block 1003). In various embodiments, the coarse sensor receiver is included on the second printed circuit board.

As described above, the fine rotor includes a fine coil, and the coarse rotor includes a coarse coil. In some embodiments, a first count per revolution of the fine coil may, in some embodiments, be greater than a second count per revolution of the coarse coil.

In some embodiments, the fine rotor is located on a first side of the first printed circuit board, and the coarse rotor is located on a second side of the first printed circuit board opposite the first side. In various embodiments, the fine sensor receiver and the coarse sensor receiver are located on a common side of the second printed circuit board. In other embodiments, the fine sensor receiver is located on a first side of the second printed circuit board, and the coarse sensor receiver is located on a second side of the second printed circuit board opposite the first side. In some cases, a first distance between the first side of the second printed circuit board and the first printed circuit board is less than a second distance between the second side of the second printed circuit board and the first printed circuit board.

The method further includes generating, by an interface circuit, an output angle value using the plurality of fine sensor signals and the plurality of coarse sensor signals (block 1004). In various embodiments, generating the output angle value includes performing a plurality of analog-to-digital conversion operations on the plurality of fine sensor signals and the plurality of coarse sensor signals. The method concludes in block 1005.

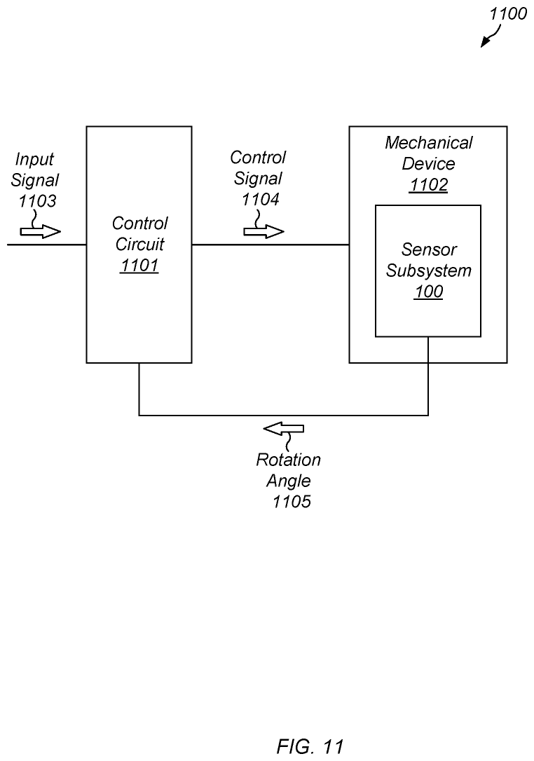

Turning to FIG. 11, a block diagram of a system configured to control rotation of a portion of a mechanical device is depicted. As illustrated, system 1100 includes control circuit 1101 and mechanical device 1102, which includes sensor subsystem 100. In various embodiments, system 1100 may be used as part of a servo motor control mechanism, a robotic limb control mechanism, a cobot control mechanism, or any other suitable control mechanism.

Control circuit 1101 is configured to receive input signal 1103. In various embodiments, input signal 1103 may be either a digital or analog circuit whose value indicates an amount to rotate all or a portion of mechanical device 1102. In various embodiments, control circuit 1101 may be configured to generate control signal 1104 using input signal 1103.

In response to receiving control signal 1104, mechanical device 1102 may be configured to rotate at least a portion of itself, e.g., a robotic limb. For example, mechanical device 1102 may be configured to activate a motor in response to an activation of control signal 1104. The motor may then cause a portion of mechanical device 1102 to rotate while control signal 1104 is active.

As described above, sensor subsystem 100 is configured to generate rotation angle 1105 based on the rotation of the portion of mechanical device 1102. In various embodiments, rotation angle 1105 may be a word of digital data including any suitable number of bits to achieve a desired resolution of rotation angle 1105.

Control circuit 1101 may be further configured to deactivate control signal 1104 based on rotation angle 1105. In various embodiments, control circuit 1101 may be configured to compare rotation angle 1105 to a desired rotation angle. In response to a determination that rotation angle 1105 is within a threshold value of the desired rotation angle, control circuit 1101 may deactivate control signal 1104. Control circuit 1101 may be implemented using a controller.

The present disclosure includes references to “an embodiment” or groups of “embodiments.” As used herein, embodiments are different implementations of instances of the disclosed concepts. References to “an embodiment,” “some embodiments,” and the like do not necessarily refer to the same embodiment. Many embodiments are possible and contemplated, including those specifically disclosed as well as modifications or alternatives that fall within the spirit or scope of the disclosure.

The above disclosure is meant to illustrate some of the principles and various embodiments of the disclosed concepts. Numerous variations and modifications will become apparent to those skilled in the art once the above disclosure is fully appreciated. It is intended that the following claims be interpreted to embrace all such variations and modifications.

What is claimed is:

1. An apparatus, comprising:
a fine rotor located on a first printed circuit board;
a metallic coarse rotor coupled to the first printed circuit board;
a fine sensor receiver configured to generate a plurality of fine sensor signals based on a first rotation of the fine rotor, wherein the fine sensor receiver is located on a second printed circuit board separate from the first printed circuit board; and
a coarse sensor receiver configured to generate a plurality of coarse sensor signals based on a second rotation of the metallic coarse rotor, wherein the coarse sensor receiver is located on the second printed circuit board.

2. The apparatus of claim 1, wherein the first printed circuit board is coupled, using at least one screw, to the metallic coarse rotor.

3. The apparatus of claim 1, wherein the first printed circuit board is coupled, using glue, to the metallic coarse rotor.

4. The apparatus of claim 1, further comprising an insulating washer between the metallic coarse rotor and the first printed circuit board.

5. The apparatus of claim 1, wherein a first distance between the first printed circuit board and the second printed circuit board is less than a second distance between the metallic coarse rotor and the second printed circuit board.

6. The apparatus of claim 1, further comprising an interface circuit configured to generate an output angle value using the plurality of fine sensor signals and the plurality of coarse sensor signals.

7. A method, comprising:
generating, by a fine sensor receiver, a plurality of fine sensor signals based on rotating a fine rotor included on a first printed circuit board;
generating, by a coarse sensor receiver, a plurality of coarse sensor signals based on rotating a metallic coarse rotor coupled to the first printed circuit board; and
generating, by an interface circuit, an output angle value using the plurality of fine sensor signals and the plurality of coarse sensor signals.

8. The method of claim 7, wherein the metallic coarse rotor is coupled to the first printed circuit board using at least one screw.

9. The method of claim 7, wherein the metallic coarse rotor is coupled to the first printed circuit board using glue.

10. The method of claim 7, wherein the metallic coarse rotor is coupled to the first printed circuit board via an insulating washer.

11. The method of claim 7, wherein the fine sensor receiver and the coarse sensor receiver are located on a second printed circuit board separate from the first printed circuit board.

12. The method of claim 11, wherein the fine sensor receiver and the coarse sensor receiver are located on a common side of the second printed circuit board.

13. The method of claim 12, wherein a first distance between the first printed circuit board and the second printed circuit board is less than a second distance between the metallic coarse rotor and the second printed circuit board.

14. An apparatus, comprising:
a first printed circuit board that includes a fine sensor receiver and a coarse sensor receiver; and
a second printed circuit board that includes:
a fine coil configured to magnetically couple to the fine sensor receiver; and
a coarse coil configured to magnetically couple to the coarse sensor receiver.

15. The apparatus of claim 14, wherein a first count per revolution of the fine coil is greater than a second count per revolution of the coarse coil.

16. The apparatus of claim 14, wherein the fine coil is located on a first side of the second printed circuit board, and wherein the coarse coil is located on a second side of the second printed circuit board opposite the first side.

17. The apparatus of claim 14, wherein the fine sensor receiver and the coarse sensor receiver are located on a common side of the first printed circuit board.

18. The apparatus of claim 14, wherein the fine sensor receiver is located on a first side of the first printed circuit board, and wherein the coarse sensor receiver is located on a second side of the first printed circuit board opposite the first side.

19. The apparatus of claim 18, wherein a first distance between the first side of the first printed circuit board and the second printed circuit board is less than a second distance between the second side of the first printed circuit board and the second printed circuit board.

20. The apparatus of claim 14, wherein the fine sensor receiver is configured to generate a plurality of fine sensor signals based on a first rotation of the fine coil, wherein the coarse sensor receiver is configured to generate a plurality of coarse sensor signals based on a second rotation of the coarse coil, and wherein the apparatus further comprises an interface circuit configured to generate an output angle value using the plurality of fine sensor signals and the plurality of coarse sensor signals.
